(19) United States
(12) Patent Application Publication
(10) Pub. No.: US 2015/0169830 A1
(43) Pub. Date: Jun. 18, 2015

(54) Data Management and Delivery System for Health Care Applications

(71) Applicants: David Medvedeff, Lake Mary, FL (US); Wuhong Li, Tampa, FL (US)

(72) Inventors: David Medvedeff, Lake Mary, FL (US); Wuhong Li, Tampa, FL (US)

(73) Assignee: VUCA HEALTH HOLDINGS LLC, Lake Mary, FL (US)

(21) Appl. No.: 14/108,811

(22) Filed: Dec. 17, 2013

(51) Int. Cl. G06F 19/00; H04N 21/262; G06F 17/30

(52) U.S. Cl. CPC G06F 19/326; G06F 17/30589; H04N 21/26258

(57) ABSTRACT

Systems, methods and computer-accessible media for collecting, managing and delivering data in the field of health care are provided. The systems, methods and computer-accessible mediums manage correlations between health care products and/or services (e.g., pharmaceuticals) and relevant information (e.g., indications and/or contraindications) for accurate and efficient delivery to system users (e.g., patients). The relevant information may be delivered in the form of video briefings, and different patient requests for information may be satisfied by common video briefing content.

### TECHNICAL FIELD

Exemplary embodiments of the present disclosure are directed to systems, methods and computer-accessible media for collecting, managing and delivering data in the field of health care and, more particularly, to systems, methods and computer-accessible media that manage correlations between health care products/services (e.g., pharmaceuticals) and relevant information (e.g., indications/contraindications) for accurate and efficient delivery to system users (e.g., patients).

### BACKGROUND

Health care services generally involve the coordinated efforts of physicians, nurses, pharmacists and suppliers of health care products, for example, pharmaceutical and medical device companies. In a typical health care process, a physician examines a patient and diagnoses health care issues, frequently with the assistance of specialists and diagnostic tests. Based on the physician's diagnosis, a course of treatment may be developed, including potential pharmaceutical prescription(s). A pharmacist is responsible for translating a physician's prescription into delivery of the requisite pharmaceutical(s) to the patient. In many instances, the physician's prescription may be “filled” by pharmaceutical products from various pharmaceutical companies. The pharmacist's selection of an appropriate pharmaceutical in a specific circumstance may be influenced by various factors, including the patient's insurance plan and the ultimate price to the patient.

The Food and Drug Administration (“FDA”) regulates the pharmaceutical industry. Thus, new pharmaceutical products must satisfy applicable regulatory requirements before receiving approval for use in the U.S. market. The FDA's approval process generally includes a review of proposed labeling for the pharmaceutical product and the proposed “uses” for the product, for example, an identification of the medical conditions for which the pharmaceutical product may be prescribed and associated dosing regimen.

Participants in providing health care services are charged with communicating relevant pharmaceutical-related information to patients, for example, the medical purpose of the pharmaceutical product, dosage information, potential side-effects, and duration of treatment. The communication process is challenging for several reasons, including time constraints on the discussions, lack of understanding and/or focus by the patient as information is conveyed by the health care professional, and frequent involvement of an intermediary (e.g., friend/relative) in “filling” the prescription at the pharmacy. Moreover, new questions concerning the pharmaceutical product may arise subsequent to the patient's opportunity to interact with the healthcare professional. Thus, it is to be expected that patients will frequently require pharmaceutical-related information at points in time after the prescription has been filled.

For patients seeking additional information concerning a pharmaceutical product, there are several available avenues for accessing relevant information. For example, a patient may contact his/her physician's office to address the question. It is rarely possible to communicate directly with the physician, particularly when the patient initially contacts the physician's office. Rather, the physician's staff (e.g., nurse or office personnel) is the patient's most likely point of contact when contacting the physician's office, and the depth of knowledge concerning the pharmaceutical question-at-issue may be limited. The patient may also contact his/her pharmacist to address the pharmaceutical-related question. Subject to applicable business hours, the pharmacist is more likely to be available to address the patient's question. However, there is an understandable reluctance on the part of patients to contact their pharmacists with what may be deemed trivial questions, particularly when the patient believes that the pharmacist already communicated the information to the patient when the prescription was filled.

Various data management systems and processes have been integrated into the health care system. For example, when a pharmacist fills a prescription, the label for the pharmaceutical product is generally computer generated at the pharmacy. The computer-generated label generally includes basic identification information (e.g., patient name, prescribing physician name, pharmacist name/address and date of prescription). In addition, the computer-generated label generally includes the name of the pharmaceutical product, dosage information and the potential for refills. Still further, the computer-generated label may include a bar code that allows the prescription to be scanned at the point-of-purchase to facilitate the billing process, the addition of the prescription to the patient's electronic records, and inventory management for the pharmacy. In certain instances, the prescription's bar code may be used to request a refill (e.g., by scanning the bar code with a smart phone “app”, such as “Refill by Scan” available from Walgreens). Subscription to the Walgreens' app also permits users to receive prescription text alerts when a prescription is ready for pick-up at the Walgreens pharmacy.

Efforts to address prescription-related challenges are also described in the patent literature. For example, U.S. Patent Publication No. 2011/0119290 to Dhoble is directed to a prescription management system or mobile healthcare manager (“MHM”) that may provide for continuing medical instruction (“CMI”) of a user following diagnosis of a medical condition of the user and/or prescription of a treatment plan for the user. For example, the MHM may allow a user to submit a request for information related to a medical product, healthcare device, medical procedure, or nutritional diet, and provide in response, rich media presentations and/or interactive CMI tutorials detailing information tailored to the specific request and user profile. The MHM may utilize various customer relationship management (“CRM”) solutions to improve a user's post-diagnosis/prescription healthcare management experience. For example, the MHM may provide tutorials in a format that is sensitive to the specific regional and cultural requirements and characteristics associated with the user. The MHM may enable a user to submit information via a mobile device and receive CMI tutorials in response on the same device and/or alternate device(s). The MHM may utilize information unique to a mobile user, such as language settings on a mobile device, personal profile information, or user location as obtained via a Global Positioning System (“GPS”), in tailoring the CMI tutorial experience to match the needs to the user. The MHM may provide patient adherence programs, for example, automatically populate a calendar of the user with information related to important dates, timelines, events, meetings, appointments and/or reminders to perform certain actions, provide newsfeeds/subscriptions/brochures to the user on topics of relevance to the user, re-fill prescription medications for the user, process shipment of medications for the user and/or the like, to facilitate easy following of prescribed treatment plans by the user.

U.S. Patent Publication No. 2012/0053955 to Martin et al. is directed to a prescription processing system that may include a capture module configured to capture information from a plurality of individual cards. At least one of the cards may include medical information including at least a medication and a dosage for a patient. The system may include an information processing module configured to generate a bitmap file associated with the captured information, extract at least a portion of the medical information from the bitmap file using optical character recognition, and assemble the extracted information to generate a prescription data file. The system may include a transmission module configured to transmit the prescription data file to a pharmacy.

U.S. Patent Publication No. 2012/0101840 to Choi is directed to a medication management system for managing a user's medication. The Choi system may analyze and obtain information required for medication by using a prescription. The system may provide an image of a prescribed medicine (e.g., a photo of the pill) to a user by using the analyzed information to allow the user to properly take a medicine, and provide information regarding medication when a medication time arrives, so that the user can take a medicine at a proper time. In addition, the system may determine whether the user takes a medicine, and manage comprehensive information regarding the user's medication situation based on the determination.

Additional patent filings of interest to the present disclosure include U.S. Patent Publication No. 2008/0290168 to Sullivan et al. which provides the source of manufacture and distributor identification based on scanning a barcode from a container label or a micro-code printed on a pill, U.S. Patent Publication No. 2007/0252378 to Chambers which incorporates pharmacy labels, U.S. Patent Publication No. 2005/0228593 to Jones which provides a medical information access tool, U.S. Patent Publication No. 2003/0055683 to Gibson et al. which provides a drug information dissemination tool, U.S. Pat. No. 8,165,895 to Nadas et al. which provides a medication management system for improving medication therapy compliance, U.S. Pat. No. 8,072,635 to Roberts et al. which provides a pharmacy printing system, U.S. Pat. No. 8,032,397 to Lawless which provides a prescription therapy and compliance system, U.S. Pat. No. 8,020,564 to Batch which provides a system for compiling and analyzing medical treatment parameters, U.S. Pat. No. 7,801,642 to Ansari et al. which provides a system for checking the accuracy of prescriptions), U.S. Pat. No. 6,731,989 to Engleson et al. which provides an automated patient care system and JP Publication No. 2010-073079 to Futaba which provides a pharmaceutical product information system.

Despite efforts to date, a need remains for improved or new systems, methods and computer-accessible mediums for collecting, managing and delivering data in the field of health care. More particularly, a need remains for designs and management methods that enable effective management of correlations between health care products/services (e.g., pharmaceuticals) and relevant information (e.g., indications/contraindications) for accurate delivery to system users (e.g., patients). Still further, a need remains for systems, methods and computer-accessible mediums that support improved health literacy and that strengthen the patient relationship by delivering patient-friendly, prescription-specific medication education via video briefings viewable on-demand anywhere on mobile devices and other computer systems that are adapted to access information from the Web. These and other needs are satisfied by the systems, methods and computer-accessible mediums of the present disclosure.

### SUMMARY

The present disclosure provides advantageous systems, methods and computer-accessible media that can deliver patient-friendly, prescription-specific medication education via video briefings viewable on-demand anywhere on mobile devices and other computer systems that are adapted to access information from the Web. The disclosed systems, methods and computer-accessible media generally include a patient engagement gateway that is adapted to deliver on-demand medication and health information videos. The videos are stored and managed in a library, for example, a database, and video links are delivered to patients via text-based (e.g., a Uniform Resource Locator (“URL”)) or graphic-based (e.g., a Quick Response (“QR”) code) information sharing technologies. Alternatively, the video hyperlinks (e.g., URLs) can be posted to and accessed from an organization's website. In exemplary embodiments of the present disclosure, the videos are created in multiple languages, for example, English and Spanish, and a desired language version can be accessed by a patient for viewing purposes. Other customizations may also be implemented to the video content, for example, to address geographic or cultural issues and opportunities.

The disclosed systems, methods and computer-accessible media advantageously leverage video library content to supply accurate pharmaceutical-related information to patients despite variable prescriptions and other variables associated with information requests. Thus, for example, the systems, methods and computer-accessible media of the present disclosure generally include functionality to automatically match multiple drug products and/or prescription parameters to appropriate video content stored in the video library based on the common applicability of video content to multiple drug product regimens. Thus, the disclosed systems, methods and computer-accessible media can advantageously correlate the information contained within individual content files stored in the video library with potential information-based inquiries from patients, thereby providing desired informational support across a host of drugs/dosages/strengths with a limited universe of video content. The “many-to-one” functionality associated with the disclosed systems, methods and computer-accessible media facilitates delivery of responsive video content to relevant end user inquiries, and permits ongoing expansion/updates to the matching functionality so as to stay abreast of ongoing drug developments, frequent changes in drug manufacturing related to National Drug Code (“NDC”) coding, and/or FDA updates.

In exemplary embodiments of the present disclosure, the disclosed systems, methods and computer-accessible media can provide back end processing that advantageously accommodates dynamic changes with respect to information after the information request (e.g., a URL or QR Code) has been created, which can include, for example, a change to a pharmacy contact number or FDA information associated with a drug.

The disclosed systems, methods and computer-accessible media can be further adapted to encode information from multiple data sources so as to facilitate capture of multi-faceted and valuable information concerning a prescription/patient when delivering a prescription to a patient. The more information that is included in the information request, the more specific and targeted the delivery can be for the patient(s). However, depending on the methods of communication as most appropriate for the patient use case scenario, either by text-based hyperlinking URLs or by graphic-based QR codes, the rich data can be encoded and/or compressed by the information request so that it can be effectively and accurately communicated to the data management system.

The disclosed systems, methods and computer-accessible media can beneficially create encoding identifiers (e.g. CueID) that are capable of encapsulating multiple identifiers and compressing them to shorten the length of data string. Furthermore, the disclosed systems, methods and computer-accessible media can include crosswalk data files that can be based on the hierarchical data structure, and can combine multiple data elements (e.g., to identify the detail of drug products and prescriptions) into a single identifier record with shortened and consistent data string. Thus, for example, the QR codes generated by a pharmacist when delivering a prescription to a patient using the disclosed systems, methods and computer-accessible media can be advantageously encoded with information concerning the patient, the pharmacy, the pharmacist, the prescription (e.g., including drug, strength, dosage) and/or demographic data.

Other objects and features of the present disclosure will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a flowchart illustrating an exemplary implementation for creating and providing exemplary video briefings according to an exemplary embodiment of the present disclosure;

FIG. 2 is a flowchart illustrating an exemplary implementation for delivering responsive information to a patient according to an exemplary embodiment of the present disclosure;

FIG. 3 is a diagram of a system for providing pharmaceutical information to a user according to an exemplary embodiment of the present disclosure;

FIG. 4 is a diagram of an exemplary NERF coding system according to an exemplary embodiment of the present disclosure;

FIG. 5 is a diagram of an exemplary SURF coding system according to an exemplary embodiment of the present disclosure;

FIG. 6 is a block diagram of an exemplary computing device configured to implement embodiments of a respondent selection engine according to an exemplary embodiment of the present disclosure; and

FIG. 7 is a computing system for implementing embodiments of a respondent selection engine according to an exemplary embodiment of the present disclosure.

### DESCRIPTION OF EXEMPLARY EMBODIMENTS

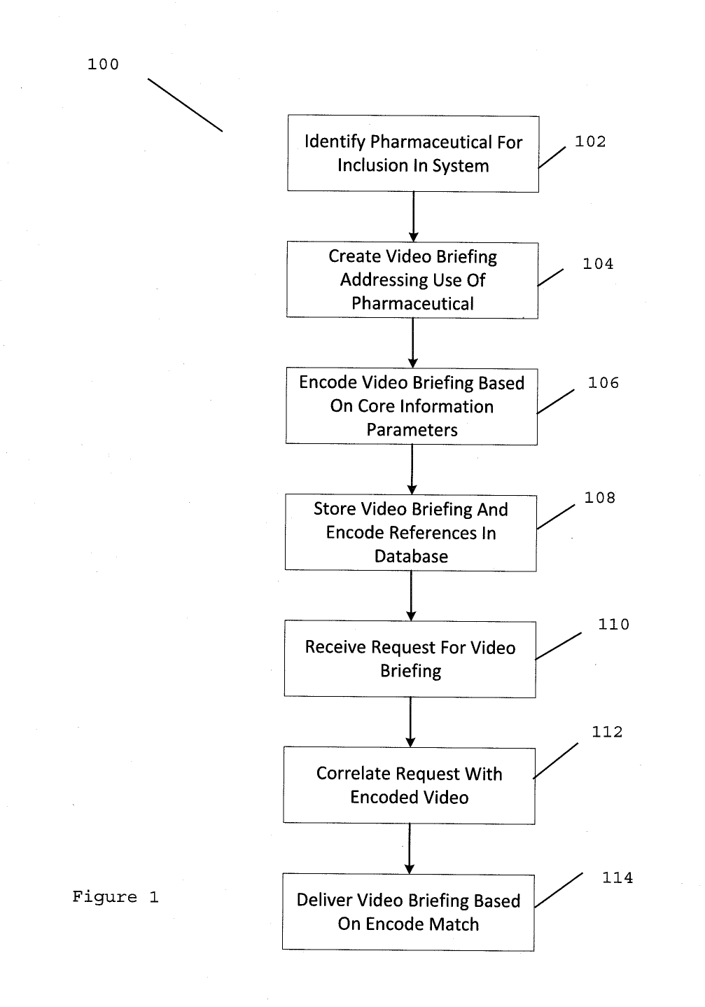

Exemplary embodiments of the present disclosure are directed to systems, methods and computer-accessible media that can deliver, inter alia, patient-friendly, prescription-specific, medication education via video briefings. The video briefings can be advantageously delivered in real time based on electronic requests and may be viewable on mobile devices and other computer systems that are adapted to access information from the Web. An exemplary implementation of the present disclosure is illustrated in the flowchart of FIG. 1.

With reference to FIG. 1, the disclosed system 100 can include a step associated with establishing a video library containing medication information of potential value to patients. Thus, in step 102, an identification of pharmaceutical products for inclusion in the video library can be undertaken. The identification of pharmaceutical products may be based on a variety of source materials, for example, FDA publications/databases, pharmaceutical manufacturer publications/databases, professional journals/publications and the like.

Once a pharmaceutical product has been identified to be the subject of a video briefing, a video briefing can be created. In that regard, relevant information is collected concerning the approved uses/indications, typical dosages, potential side effects, and the like. Relevant information may be based on a variety of sources, for example, FDA publications/databases, pharmaceutical manufacturer publications/databases, professional journals/publications and the like.

In creating a video briefing for an individual pharmaceutical product, it may be desirable to create the digital file with distinct modules or subsections. For example, it may be desirable to include a first module that generally addresses the uses/indications for the pharmaceutical product, a second set of modules that generally address various treatment modalities, for example, different dosages administration routes and/or forms of pharmaceutical products (e.g., tablet vs. capsule vs. suppository, etc.), a third module that generally addresses potential side effects, and additional module(s) to address other informational points associated with the pharmaceutical product, including information associated with the FDA approval for the product.

By developing module-based digital files, it is possible to leverage video briefing content that has broader application than a single pharmaceutical product. For example, it may be possible to utilize a single video briefing module addressing suppository administration of a pharmaceutical product for any and all suppositories. Similarly, it may be possible to utilize a single video briefing module addressing a particular potential side effect (e.g., loss of appetite) to address the noted side effect across any and all products that are subject to the noted potential side effect.

Thus, with further reference to the flowchart of FIG. 1, step 104 generally involves encoding of the video briefing based on the content of the video briefing, for example, on a module-by-module basis. For example, the video briefing may be encoded based on the underlying active ingredient of the pharmaceutical product, thereby permitting a routing of patient requests to the noted video briefing regardless of the identity of the pharmaceutical manufacturer and/or brand name. More specifically, the disclosed system is advantageously adapted to match a patient request for a given brand name drug, or the equivalent generic drug, to the same video briefing, since the information relevant to the patient will be the same. In this way, the coding of the video files stored in the video library allows patient requests for information associated with distinct, but pharmaceutically identical, products to be matched with appropriate digital files. In this way, the disclosed system, method and computer-accessible medium can leverage the contents of a video file library to address patient inquiries across a multitude of pharmaceutical products. This functionality may be termed a “many-to-one” matching functionality that limits the cost/expense and storage requirements required to address patient inquiries across a range of pharmaceutical products.

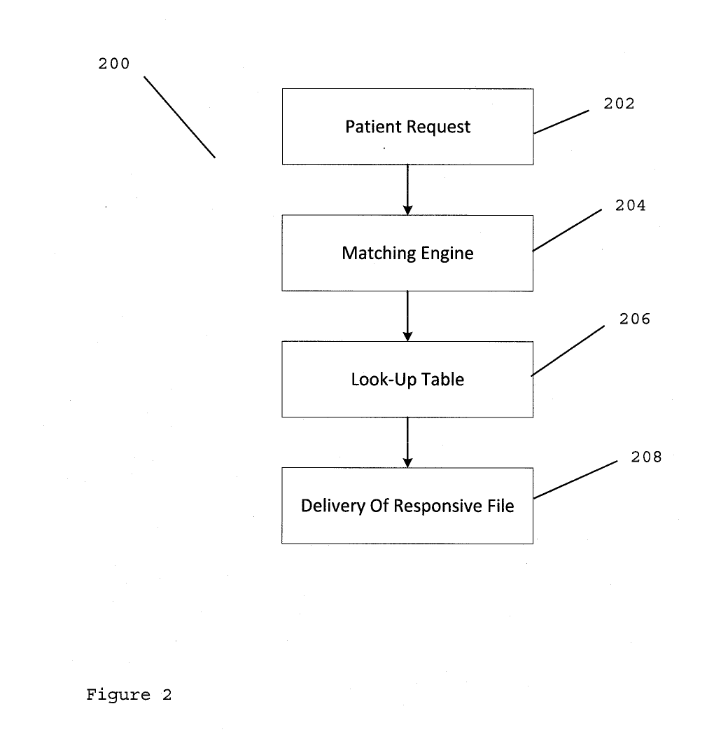

An exemplary implementation of the “many-to-one” matching functionality associated with the present disclosure is illustrated in the flowchart of FIG. 2. In particular, system 200 is adapted to receive a patient request 202, and deliver the patient request to a matching engine 204. The matching engine 204 can automatically parses the patient request to determine the pharmaceutical product of interest to the patient. In an exemplary embodiment of the present disclosure, the specific pharmaceutical request embodied in the patient request is directed to a look-up (e.g., a lookup table), step 206, where indexed information concerning the coded modules of the video briefings is stored. The system 200 identifies the video briefing module(s) to be delivered to the patient in response to the patient request. In exemplary implementations of the present disclosure, the video briefing module(s) delivered to the patient constitute a series of components that together provide fully responsive information.

For example, parsing of the patient request may determine that the patient has been prescribed a branded pharmaceutical product for a specific condition/indication at 20 mg strength, in tablet form, for administration twice per day (e.g., with meals). The matching engine 204 identifies the video briefing module(s) that correlate to (i) the noted pharmaceutical product when prescribed for the noted condition/indication, (ii) tablet administration twice per day with meals, and (iii) generic information concerning contact with pharmacist/physician if conditions persist or side effects are noted, etc. Thus, at step 208, the appropriate video briefing module(s) are delivered to the patient in a predetermined sequence that ensures that the information is received in an understandable/logical order.

The exemplary look-up table may include a variety of additional parameters to facilitate delivery of patient-friendly video briefings. For example, parsing of the patient request may determine that the patient prefers Spanish language content, and the look-up table may include indexing information that is based on language (e.g., Spanish). Similarly, parsing of the patient request may determine that the patient has already refilled the prescription on one or more occasions, and the look-up table may include indexing information that is specific to refill-related status and/or next steps. Thus, the disclosed system is designed to accommodate indexing of all aspects of the video library and to allow the matching engine to identify responsive video briefing module(s) that are responsive to specific patient requests in real time.

Returning to FIG. 1, the encoded video briefing is stored in a database at step 108 and the coding information is added to the indexing associated with the system's look-up table. The video briefing thus becomes available for delivery to patients in response to targeted information requests.

At step 110, system 100 receives a patient request for a video briefing, the request is correlated with available video briefing content based on encoded information associated with the video briefing content (step 112), and responsive video briefing content is delivered to the patient (step 114). As will be readily apparent, steps 110-114 in FIG. 1 align with steps 202-208 in FIG. 2. However, system 200 of FIG. 2 provides additional detail concerning the matching functionality associated with the present disclosure.

The disclosed systems, methods and computer-accessible mediums advantageously leverage video library content to supply accurate pharmaceutical-related information to patients despite variable prescriptions and other variables associated with information requests. Thus, for example, the systems, methods and computer-accessible mediums of the present disclosure include functionality to automatically match multiple drug products and/or prescription parameters to appropriate video content stored in the video library based on the common applicability of video content to multiple drug product regimens. Thus, the disclosed systems, methods and computer-accessible mediums correlate the information contained within individual content files stored in the video library with potential information-based inquiries from patients, thereby providing desired informational support across a host of drugs/dosages/strengths with a limited universe of video content. The “many-to-one” functionality associated with the disclosed systems, methods and computer-accessible mediums facilitates delivery of responsive video content to relevant end user inquiries, and permits ongoing expansion/updates to the matching functionality so as to stay abreast of ongoing drug developments, frequent changes in drug manufacturing related to NDC coding and/or FDA updates.

In exemplary embodiments of the present disclosure, the disclosed system provides back end processing that accommodates dynamic changes with respect to information after encoding is complete, for example, a change to a pharmacy contact number or FDA information associated with a drug. Thus, the exemplary systems, methods and computer-accessible mediums can utilize a different video in the event the information for a particular drug changes. For example, if a particular drug is introduced with a different route of administration, then the video for the new route of administration can be utilized without the need the create new informational videos for the drug.

The disclosed systems, methods and computer-accessible mediums may support and/or facilitate ancillary features and functions of benefit to pharmacists, patients, insurance companies and others involved in the health care industry. For example, the disclosed systems, methods and computer-accessible mediums may be adapted to deliver value-added services across the same information platform, for example, one-click access to a patient's preferred pharmacy phone number or call center, one-click access to a patient's preferred online information resources, and automated, or on-demand, medication refill and reminder alert functionalities.

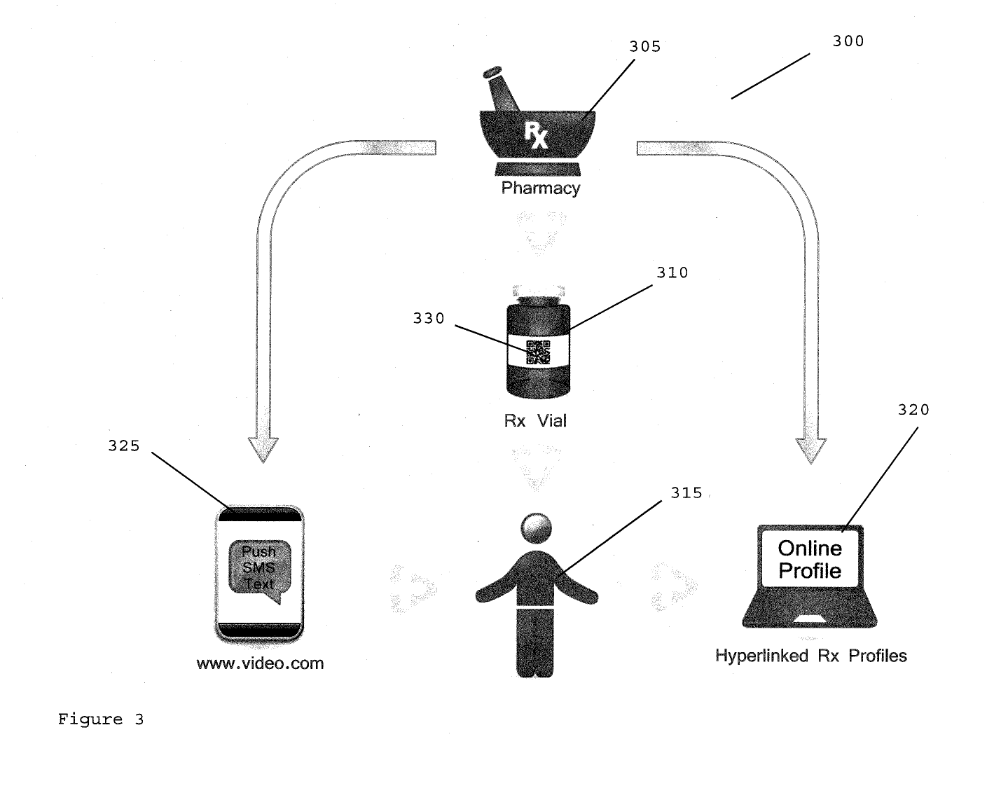

Referring to FIG. 3, an exemplary schematic is shown of an exemplary system 300 illustrating use by a pharmacy and a user. The exemplary systems, methods and computer-accessible mediums can be used and incorporated by a pharmacy 305. The exemplary systems, methods and computer-accessible mediums can be located at a remote location (e.g., a remote server), which can be accessed by pharmacy 305 each time information is requested. Alternatively, the exemplary systems, methods and computer-accessible mediums can be located on-site (e.g., at the pharmacy), for local access. If the exemplary systems, methods and computer-accessible mediums are located at the pharmacy, the system for generating the link to the accessible information can be periodically updated to include information or links to new drugs.

A patient 315 can enter pharmacy 305 in order to fill a prescription. The prescription can be a new prescription or a refill of an existing prescription. A pharmacist (not shown) can fill the requested prescription, putting the medication into a vial or prescription bottle 310. The pharmacist can print out the label for vial 310, and the label can include a link (e.g., encoded in QR code 330) for patient 315 to access information about the medication they are taking. Once the user receives vial 310, the user can scan the QR code (e.g., using mobile phone 325) and the user can be given access to various information about the medication they were prescribed. Patient 315 can also access the information online using a standard computer 320 (e.g., PC or MAC, laptop or desktop). Patient 315 can setup a profile that can be stored for later access. The profile can store information about the current medication they are taking as well as any medication they have previously taken.

The disclosed systems, methods and computer-accessible mediums are further adapted to encode information from multiple data sources so as to facilitate capture of multi-faceted and valuable information concerning a prescription/patient when delivering a prescription 310 to a patient 315. The more information is included in the information request, the more specific and targeted the delivery can be for the patients. Depending on the methods of communication as most appropriate for the patient use case scenario, either by text-based hyperlinking URLs or by graphic-based QR codes 330, the rich data required utilized can be encoded and compressed such that it can be effectively and accurately communicated to the data management system. The disclosed systems, methods and computer-accessible mediums can create encoding identifiers (e.g. CueID) that are capable of encapsulating multiple identifiers and compressing them to shorten the length of data string. Furthermore, the disclosed systems, methods and computer-accessible mediums can utilize crosswalk data files that can be based on a hierarchical data structure, and can combine multiple data elements into a single identifier record with shortened and consistent data strings to properly identify the detail of drug products and prescriptions. Thus, for example, the QR codes 330 generated by a pharmacist when delivering a prescription 310 to a patient 315 using the disclosed systems, methods and computer-accessible mediums may be advantageously encoded with information concerning the patient 315, the pharmacy 305, the pharmacist, the prescription 310, including drug, strength, and dosage, and/or demographic data.

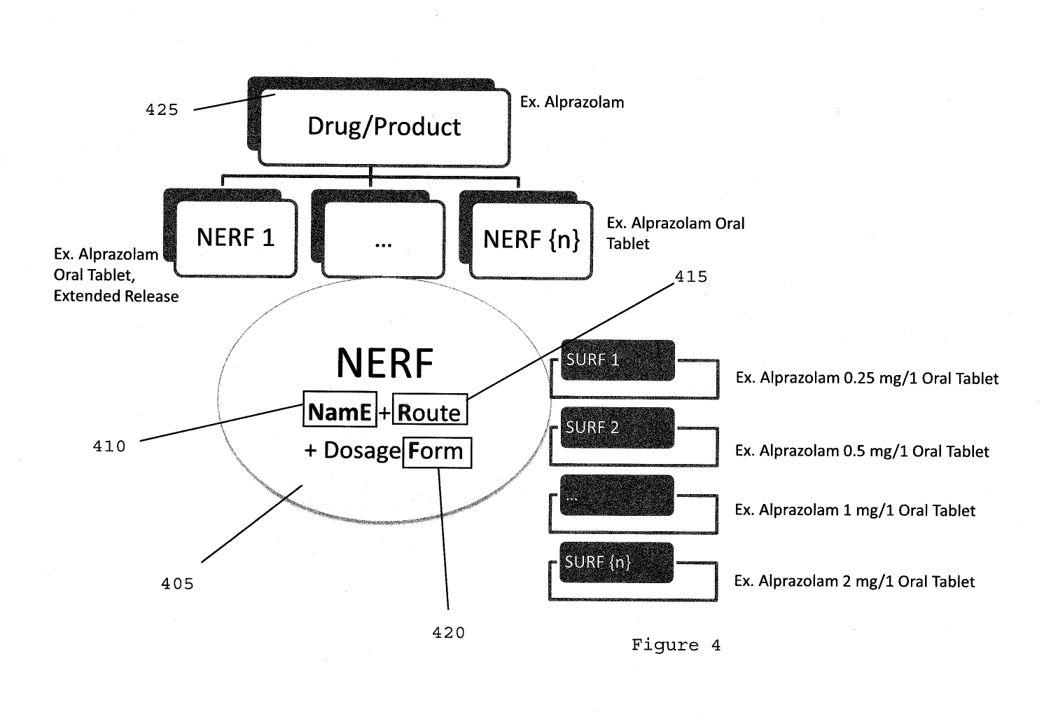

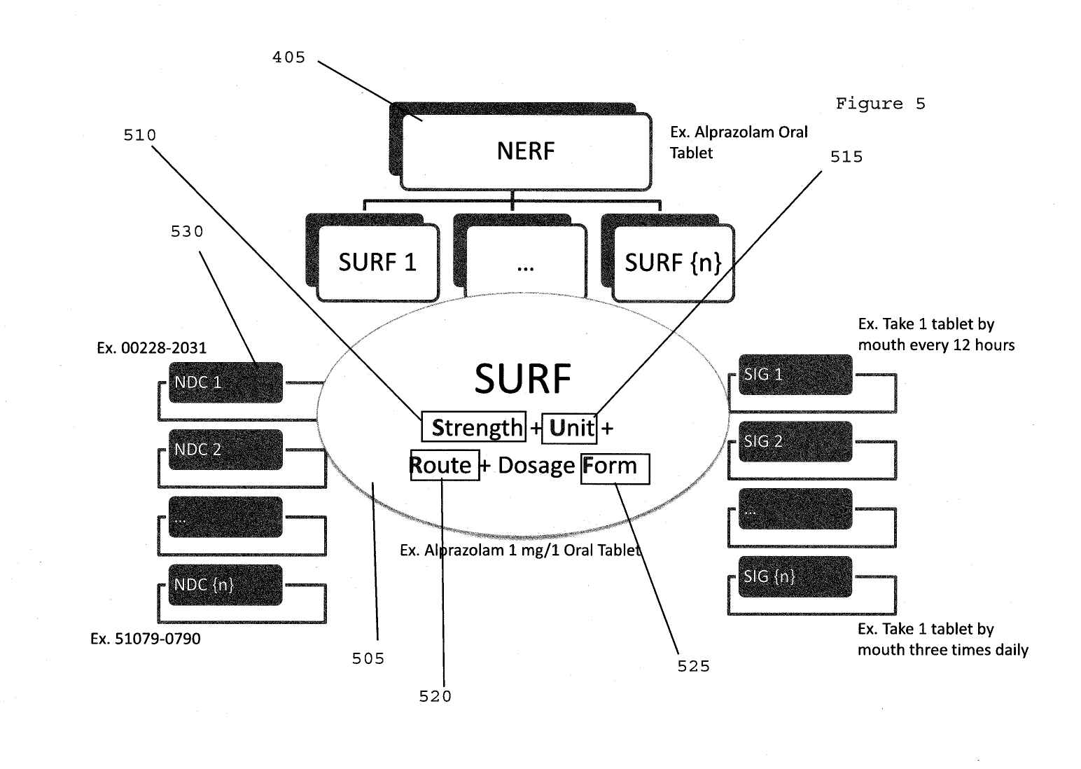

The exemplary systems, methods and computer-accessible mediums can incorporate a database having a hierarchical data structure to store information related to the pharmaceutical drug. The exemplary hierarchical database can significantly reduce data redundancy via data normalization utilizing thus enabling massive automatic creation or updates as described in Referring to FIGS. 4 and 5, the exemplary systems, methods and computer-accessible mediums can leverage the information that can be common to multiple entries to facilitate the generation of a hierarchical structure. For example, in exemplary embodiments of the present disclosure, prescription-related information may be coded using an exemplary coding system called “NERF” (405), which can include: a NamE (“NE”) (410), Route of administration (“R”) (415), and dosage Form (“F”) (420), which can together be referred to as the NERF 405. Additionally, an exemplary coding system called “SURF” 505 can be created which can include: Strength (“S”) (510), Unit (“U”) (415), Route of administration (“R”) (520), and dosage Form (“F”) (525), which can together be referred to as SURF 505. The exemplary NERF 405 and SURF 505 coding systems can facilitate synthesis of variable information into a uniform data collection and hierarchical data structure.

The exemplary NERF 405 and SURF 505 coding systems can be utilized separately or together. For example, the exemplary SURF 505 can be nested under the exemplary NERF 505, utilizing the Route of administration (R) 415 and dosage Form (F) 420 from the exemplary NERF 405. Therefore the (R) 415 and (F) 420 from the NERF 405 can be applied and used in the SURF 505, minimizing the total data allowance and number of entries needed for the exemplary SURF 505 coding system.

These exemplary coding systems (e.g., NERF 405 and SURF 505), coupled with Drug Product Names 425 and NDC 530, can form a complete hierarchical data structure that can address the needs to collect, manage and deliver medication information and videos at any granular levels specified in the information requests which can range from the most general drug product name level to NERF 405, SURF 505 or the NDC 530 level. Thus, the “strength” and “unit” of a prescription can work in tandem (e.g., 20 mg). The “route of administration” can differentiate between, for example oral, topical and other routes of administration. The “dosage form” can differentiate, for example, between capsules, tablets, liquid and other forms of delivery. The manufacturer/brand of a pharmaceutical can be irrelevant to the exemplary NERF and SURF coding systems because the parameters associated with the NERF and SURF coding system can be dictated by aspects of the pharmaceutical product that are independent thereof.

The disclosed systems, methods and computer-accessible mediums can further take advantage of the exemplary hierarchical data structure to enable massive automatic creation or updates of association of medication videos and relevant information with pharmaceutical products at the lower “child” levels once their higher “parent” level's association is updated, without the need to create or update each and every record at its child levels, for example, utilizing the exponential nature of some pharmaceutical products' hierarchy (e.g. for a single drug product name “Alprazolam”, there can be 4 child level NERFs and 13 grandchild level SURFs and 195 NDC9 records at the its most granular levels), the disclosed hierarchical data structure and its implementation can ensure exponentially efficient ways to systematically and automatically collect, create, update, manage and deliver videos and information for any given drug products at a level that is most specific to the information request. The disclosed systems, methods and computer-accessible mediums can also leverage the hierarchical data structure upon input of a modified version of an existing drug. For example, a new NDC can be received as an update from the FDA database, which may contain the same information of the existing drug at the SURF level (i.e. same drug, same strength, same route of administration and same dosage form). Once the new information has been received, the exemplary systems, methods and computer-accessible mediums, utilizing the hierarchical structure, can efficiently locate its proper parent (i.e. SURF), and then place a new entry for the modified version of the drug under the parent entry, applying information from the parent entry to the modified version, thus inheriting all information of the parent SURF entry

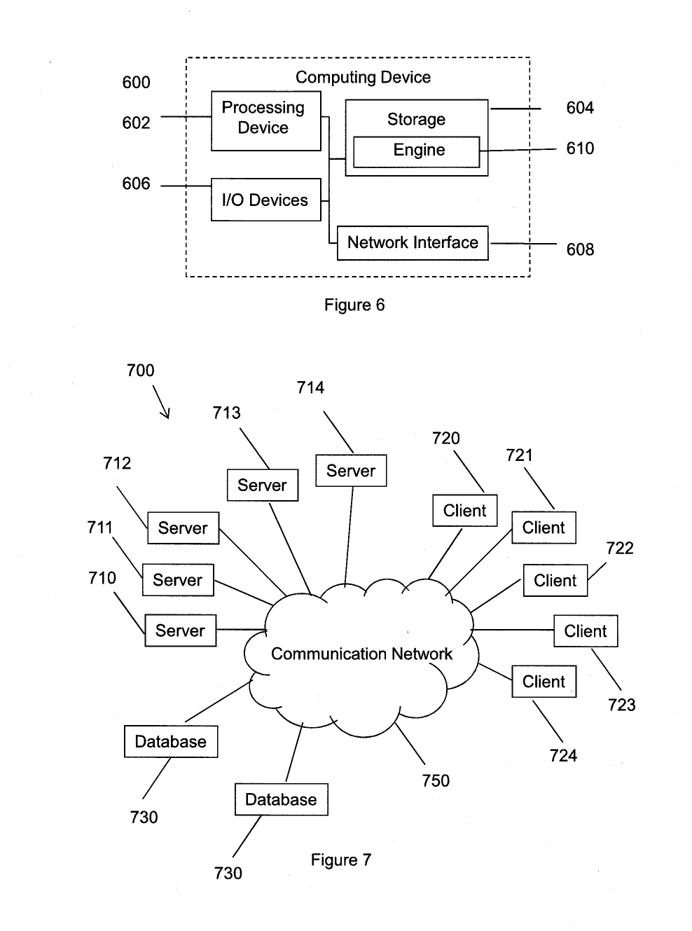

FIG. 6 is a block diagram of an exemplary computing device 600 configured to implement exemplary embodiments of the present disclosure. The computing device 600 can be a, personal computer (“PC”), laptop computer, workstation, handheld device, such as a portable digital assistant (“PDA”), and the like. In the illustrated embodiment, the computing device 600 includes a processing device 602, such as a central processing device, and can include a computer storage device 604 (hereinafter “storage 604”). The computing device 600 can further include input/output devices 606, such as a display device, keyboard, touch screen, mouse, printer, and the like, and can include a network interface 608 to facilitate communication between the computing device 600 and other devices communicative coupled to a network.

The storage 604 stores data and instructions and can be implemented using non-transitory computer readable storage medium technologies, such as a floppy drive, hard drive, tape drive, Flash drive, optical drive, read only memory (“ROM”), random access memory (“RAM”), and the like. For example, the storage 604 can store video briefing files and indexing/coding information, for example, in the form of a look-up table. Applications of the present disclosure, or portions thereof, can be resident in the storage 604, and can include instructions for implementing the applications. The storage 604 can be local or remote to the computing device 600. The processing device 602 operates to run the applications in storage 604 by executing instructions therein and storing data resulting from the executed instructions, such as patient requests, parsing instructions, matching functionality, video content delivery functionality, and the like.

FIG. 7 is a block diagram of an exemplary computing system 700 configured to implement one or more embodiments of the present disclosure. The computing system 700 includes servers 710-714 operatively coupled to clients 720-724, via a communication network 750, which can be any network over which information can be transmitted between devices communicatively coupled to the network. For example, the communication network 750 can be the Internet, Intranet, virtual private network (“VPN”), wide area network (“WAN”), local area network (“LAN”), wired or wireless, and the like. The computing system 700 can include repositories or database devices 730, which can be operatively coupled to the servers 710-714, as well as to clients 720-724, via the communications network 750. The servers 710-714, clients 720-724, and database devices 730 can be implemented as computing devices. Those skilled in the art will recognize that the database devices 730 can be incorporated into one or more of the servers 710-714 such that one or more of the servers can include databases.

In an exemplary embodiment, the functionalities associated with the present disclosure can be distributed among different devices (e.g., servers, clients, databases) in the communication network 750 such that one or more components, or portions thereof, can be implemented by different devices in the communication network 750. For example, in illustrative embodiments, parsing functionality associated with receipt of a patient request can be implemented by the server 710, matching functionality can be implemented by the server 711, and video file delivery can be implemented by the server 712.

In exemplary implementations of the present disclosure, the communication network 750 can include a patient engagement gateway that is adapted to deliver on-demand medication and health information videos. The videos are stored in a library, for example, database 730, and video links are delivered to patients via text-based or graphic-based information sharing technologies. Alternatively, the video links can be posted to and accessed from an organization's website. In exemplary embodiments of the present disclosure, the videos are created in multiple languages, for example, English and Spanish, and a desired language version is accessed by a patient for viewing purposes. Other customizations may also be implemented to the video content, for example, to address geographic or cultural issues and opportunities.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. It should be understood that the exemplary procedures described herein can be stored on any computer accessible medium, including a hard drive, RAM, ROM, removable disks, CD-ROM, memory sticks, etc., and executed by a processing arrangement and/or computing arrangement which can be and/or include a hardware processors, microprocessor, mini, macro, mainframe, etc., including a plurality and/or combination thereof. In addition, certain terms used in the present disclosure, including the specification, drawings and numbered paragraphs thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1. A non-transitory computer-accessible medium having stored thereon computer-executable instructions for generating a hierarchical database of pharmaceutical information, wherein, when a computer hardware arrangement executes the instructions, the computer arrangement is configured to perform procedures comprising:
receiving first information related to a plurality of pharmaceutical drugs including multiple version of a particular pharmaceutical drug; and
generating a hierarchical database of pharmaceutical information based on the first information by incorporating information from the particular pharmaceutical drug into the multiple versions of the particular pharmaceutical drug;
wherein the hierarchical database includes a name of the pharmaceutical drugs, a strength of the pharmaceutical drugs, a unit of the pharmaceutical drugs, a route of administration of the pharmaceutical drugs, and a dosage of the pharmaceutical drugs.

2. The computer-accessible medium of claim 1, wherein the computer arrangement is further configured to:
receive second information related to at least one further pharmaceutical drug; and
match the at least one further pharmaceutical drug to one of the pharmaceutical drugs.

3. The computer-accessible medium of claim 2, wherein the computer arrangement is further configured to generate third information for the at least one further pharmaceutical drug based on the first information of the matched one of the pharmaceutical drugs and the second information.

4. The computer-accessible medium of claim 3, wherein the third information is stored in the hierarchical database.

5. The computer-accessible medium of claim 3, wherein the third information includes the name of the matched one of the pharmaceutical drugs, the strength of the matched one of the pharmaceutical drugs, the unit of the matched one of the pharmaceutical drugs, the route of administration of the matched one of the pharmaceutical drugs, and the dosage of the matched one of the pharmaceutical drugs.

6. The computer-accessible medium of claim 2, wherein the second information includes a national drug code.

7. The computer-accessible medium of claim 1, wherein the hierarchical database includes a drug product identification number, a name/route of administration/dosage form (NERF) identification number, and a strength/unit/route of administration/dosage form (SURF) identification number for the pharmaceutical drugs.

8. The computer-accessible medium of claim 3, wherein the hierarchical database includes a drug product identification number, a name/route of administration/dosage form (NERF) identification number, and a strength/unit/route of administration/dosage form (SURF) identification number for the pharmaceutical drugs.

9. The computer-accessible medium of claim 8, wherein the third information includes the drug product identification number, the NERF number, and the SURF number of the matched one of the pharmaceutical drugs.

10. The computer-accessible medium of claim 1, wherein the computer arrangement is further configured to generate a list of videos related to the first information.

11. The computer-accessible medium of claim 10, wherein the computer arrangement is further configured to generate fourth information related to an identifier of the list of videos and provide the fourth information to at least one user.

12. The computer-accessible medium of claim 11, wherein the computer arrangement is further configured to receive the fourth information from the at least one user and provide access to videos corresponding to the list of videos to the at least one user.

13. The computer-accessible medium of claim 12, wherein the fourth information is received from a smartphone of the at least one user.

14. The computer-accessible medium of claim 13, wherein the computer-arrangement is further configured to play the videos on the smartphone of the at least one user.

15. The computer-accessible medium of claim 11, wherein the fourth information is encoded in a quick response (QR) code.

16. The computer-accessible medium of claim 15, wherein the computer arrangement is further configured to print the QR code on a prescription bottle.

17. The computer-accessible medium of claim 11, wherein the fourth information is encoded in a uniform resource locator.

18. The computer-accessible medium of claim 6, wherein the computer arrangement is further configured to receive the NDC from a Federal Drug Administration database.

19. A method for generating a hierarchical database of pharmaceutical information, comprising:
receiving first information related to a plurality of pharmaceutical drugs including multiple version of a particular pharmaceutical drug; and
using a computer hardware arrangement, generating a hierarchical database of pharmaceutical information based on the first information by incorporating information from the particular pharmaceutical drug into the multiple versions of the particular pharmaceutical drug;
wherein the hierarchical database includes a name of the pharmaceutical drugs, a strength of the pharmaceutical drugs, a unit of the pharmaceutical drugs, a route of administration of the pharmaceutical drugs, and a dosage of the pharmaceutical drugs.

20. A system for generating a hierarchical database of pharmaceutical information, comprising:
a computer hardware arrangement configured to:
receive first information related to a plurality of pharmaceutical drugs including multiple version of a particular pharmaceutical drug; and
generate a hierarchical database of pharmaceutical information based on the first information by incorporating information from the particular pharmaceutical drug into the multiple versions of the particular pharmaceutical drug;
wherein the hierarchical database includes a name of the pharmaceutical drugs, a strength of the pharmaceutical drugs, a unit of the pharmaceutical drugs, a route of administration of the pharmaceutical drugs, and a dosage of the pharmaceutical drugs.
